(19) United States
(12) Patent Application Publication
(10) Pub. No.: US 2012/0305036 A1
(43) Pub. Date: Dec. 6, 2012

(54) DEVICE FOR TREATING SURFACES OF WAFER-SHAPED ARTICLES

(75) Inventors: Otto LACH, TREFFEN (AT); Ulrich TSCHINDERLE, FEISTRITZ/GAIL (AT); Markus JUNK, VILLACH (AT)

(73) Assignee: LAM RESEARCH AG, VILLACH (AT)

(21) Appl. No.: 13/150,817

(22) Filed: Jun. 1, 2011

(51) Int. Cl. B08B 3/00

(52) U.S. Cl. 134/137

(57) ABSTRACT

A device for liquid treatment of a wafer-shaped article comprises a closed process chamber, and a ring chuck located within the closed process chamber. The ring chuck is adapted to be driven without physical contact through a magnetic bearing. A magnetic stator surrounds the closed process chamber. The closed process chamber has a cylindrical wall positioned between the ring chuck and the magnetic stator during liquid treatment of a wafer-shaped article. Various structures are provided to prevent upward ingress of processing liquid into a gap defined between the ring chuck and the cylindrical wall.

### BACKGROUND OF THE INVENTION

1. Field of the Invention

The invention relates generally to an apparatus for treating surfaces of wafer-shaped articles, such as semiconductor wafers, wherein one or more treatment fluids may be recovered from within a closed process chamber.

2. Description of Related Art

Semiconductor wafers are subjected to various surface treatment processes such as etching, cleaning, polishing and material deposition. To accommodate such processes, a single wafer may be supported in relation to one or more treatment fluid nozzles by a chuck associated with a rotatable carrier, as is described for example in U.S. Pat. Nos. 4,903,717 and 5,513,668.

Alternatively, a chuck in the form of a ring chuck adapted to support a wafer may be located within a closed process chamber and driven without physical contact through an active magnetic bearing, as is described for example in International Publication No. WO 2007/101764 and U.S. Pat. No. 6,485,531. Treatment fluids which are driven outwardly from the edge of a rotating wafer due to centrifugal action are delivered to a common drain for disposal.

Commonly-owned U.S. patent application Ser. Nos. 12/787,196 (filed May 25, 2010) and 12/842,836 (filed Jul. 23, 2010) and WO2010/113089 disclose improved constructions for ring chucks, in which the wafer is suspended from the underside of the ring chuck by downwardly projecting gripping pins.

### SUMMARY OF THE INVENTION

The present inventors have discovered that, in chucks of the type described above, treatment liquids expelled from a wafer surface are not routed entirely as intended. In particular, despite the ring chuck being shaped to direct treatment fluid downwardly and outwardly of the wafer and ring chuck, the present inventors have discovered that there is a tendency for a part of the treatment liquid to migrate upwardly into the relatively narrow gap between the ring chuck and a surrounding cylindrical wall.

The present invention therefore provides a device for liquid treatment of a wafer-shaped article, comprising a closed process chamber, a ring chuck located within the closed process chamber, the ring chuck being adapted to be driven without physical contact through a magnetic bearing, a magnetic stator surrounding the closed process chamber, the closed process chamber comprising a cylindrical wall positioned between the ring chuck and the magnetic stator during liquid treatment of a wafer-shaped article, and the ring chuck has a form for preventing upward ingress of processing liquid into a gap defined between the ring chuck and the cylindrical wall.

In preferred embodiments of the present invention, the ring chuck comprises a downwardly-depending spoiler extending from a downwardly-facing surface of the ring chuck.

In preferred embodiments of the present invention, the spoiler extends from the ring chuck in a more vertical orientation than the downwardly-facing surface of the ring chuck from which it extends.

In preferred embodiments of the present invention, the ring chuck comprises a downwardly-facing fluid-directing surface that extends at an oblique angle to an axis of rotation of the ring chuck, and the ring chuck further comprises at least one downwardly-facing annular concave surface formed in a radially outer region of the downwardly-facing fluid-directing surface of the ring chuck.

In preferred embodiments of the present invention, the ring chuck comprises two downwardly-facing annular concave surfaces formed in a radially outer region of the downwardly-facing fluid-directing surface of the ring chuck, wherein the two downwardly-facing annular concave surfaces are adjacent to one another and separated from one another by a discontinuity in the downwardly-facing fluid-directing surface of the ring chuck.

In preferred embodiments of the present invention, the ring chuck comprises a downwardly- and inwardly-facing fluid-directing surface that extends at an oblique angle to an axis of rotation of the ring chuck, and the ring chuck further comprises an annular slit formed in the downwardly- and inwardly-facing fluid-directing surface of the ring chuck, the slit being dimensioned so as to disrupt a liquid flow across the downwardly- and inwardly-facing fluid-directing surface of the ring chuck.

In preferred embodiments of the present invention, the ring chuck comprises a downwardly-facing fluid-directing surface that extends at an oblique angle to an axis of rotation of the ring chuck, and the ring chuck further comprises a series of openings formed in a radially outer region of the downwardly-facing fluid-directing surface of the ring chuck.

In preferred embodiments of the present invention, the ring chuck comprises a downwardly-facing fluid-directing surface that extends at an oblique angle to an axis of rotation of the ring chuck, and the ring chuck further an annular concave fluid trap formed in a radially outwardly facing surface of the ring chuck that is positioned radially outwardly of and axially above the downwardly-facing fluid-directing surface of the ring chuck.

In preferred embodiments of the present invention, the device is a spin chuck in a process module for single wafer wet processing.

In preferred embodiments of the present invention, the ring chuck comprises a series of contact elements projecting downwardly from the ring chuck and adapted to hold a wafer-shaped article suspended from an underside of the ring chuck.

In preferred embodiments of the present invention, the contact elements are a series of pins that are conjointly movable between a radially inner position in which they contact a wafer-shaped article to a radially outer position in which they release the wafer-shaped article.

In preferred embodiments of the present invention, the pins are arranged in a circular series, and each pin projects from a respective pivotal base along an axis parallel to and offset from a pivot axis of said pivotal base.

In preferred embodiments of the present invention, the device further comprises a vertical movement actuator operatively associated with the stator.

In preferred embodiments of the present invention, the vertical movement actuator is operatively associated with the stator through a magnetic couple.

In preferred embodiments of the present invention, the magnetic bearing is an active magnetic bearing.

### BRIEF DESCRIPTION OF THE DRAWINGS

Other objects, features and advantages of the invention will become more apparent after reading the following detailed description of preferred embodiments of the invention, given with reference to the accompanying drawings, in which:

FIG. 1 is a cross-sectional side view of a process chamber according to an embodiment of the invention, shown in a wafer loading/unloading status;

FIG. 2a is a cross-sectional perspective view of the detail II in FIG. 1, depicting a ring chuck construction according to a predecessor design;

FIG. 2b is a cross-sectional perspective view of the detail II in FIG. 1, depicting a ring chuck construction according to an embodiment of the present invention;

FIG. 2c is a cross-sectional perspective view of the detail II in FIG. 1, depicting a ring chuck construction according to an embodiment of the present invention;

FIG. 2d is a cross-sectional perspective view of the detail II in FIG. 1, depicting a ring chuck construction according to an embodiment of the present invention;

FIG. 2e is a cross-sectional perspective view of the detail II in FIG. 1, depicting a ring chuck construction according to an embodiment of the present invention;

FIG. 2f is a cross-sectional perspective view of the detail II in FIG. 1, depicting a ring chuck construction according to an embodiment of the present invention;

FIG. 3 is a perspective view, partly in section, illustrating a device according to another embodiment of the present invention;

FIG. 4 is a perspective view, also partly in section, of the detail IV of FIG. 4; and

FIG. 5 is a view corresponding to that of FIG. 4, in which the stator and hence also the chuck have been elevated relative to the cylindrical wall of the process chamber, and in which the chuck is in a different angular orientation to expose a pin assembly.

### DETAILED DESCRIPTION OF PREFERRED EMBODIMENTS

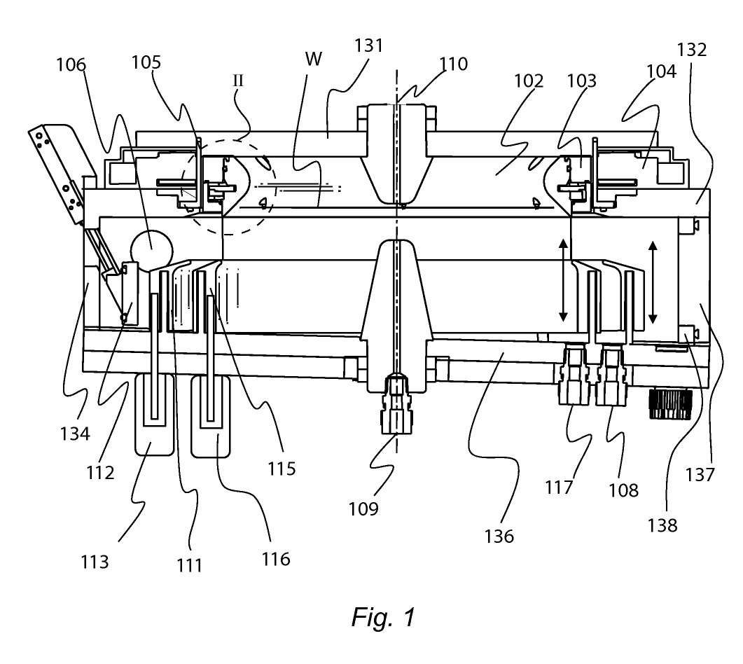

Referring to FIG. 1, a closed process chamber is defined by an upper chamber having an open bottom region which is seated atop a larger lower chamber having an open top region. The perimeter of the upper chamber is defined by a cylindrical chamber wall (105). The cylindrical chamber wall (105) comprises a vertically oriented cylindrical wall having an upper end and an outwardly extending radial flange at its lower end.

An inner cover plate (131) is seated upon the upper end of the cylindrical chamber wall (105) so as to provide a closed top surface of the upper chamber, extending within the interior of the cylindrical chamber wall (105). The inner cylindrical plate (131) also extends radially outwardly from the upper end of the cylindrical chamber wall (105). Thus, the upper chamber of the closed process chamber comprises an interior region formed below the inner cover plate (131) and within the cylindrical chamber wall (105).

The lower chamber of the closed process chamber, which is larger than the upper chamber, is formed from below by a bottom plate (136). A frame (138) comprises vertical walls which are joined about the periphery of the bottom plate (136) so as to form vertically extending sidewalls of the lower chamber. A wafer loading and unloading access door (134) is provided within one wall of the frame (138) and a maintenance access door is provided within another wall of the frame (138).

Opposite the bottom plate (136), the frame (138) is joined to an inwardly extending annular cover plate (132), so as to form an annular top surface of the lower chamber. Thus, the lower chamber of the closed process chamber comprises an interior region formed above the bottom plate (136), within the frame (138) and below the annular cover plate (132).

The annular cover plate (132) is seated at its inner peripheral edge against the horizontally extending flange of the lower end of the cylindrical chamber wall (105), so as join the upper and lower chambers to form the closed process chamber.

A ring chuck (102) is located within the upper chamber. Ring chuck (102) is adapted to rotatably support a wafer (W). Preferably, ring chuck (102) comprises a rotatable drive ring having a plurality of eccentrically movable gripping members for selectively contacting and releasing the peripheral edge of a wafer.

In the embodiment shown in FIG. 1, the ring chuck (102) comprises a ring rotor (103) provided adjacent to the interior surface of the cylindrical chamber wall (105). A stator (104) is provided opposite the ring rotor adjacent the outer surface of the cylindrical chamber wall (105). The rotor (103) and stator (104) serve as a motor by which the ring chuck (and thereby a supported wafer) may be rotated through an active magnetic bearing. For example, the stator (104) can comprise a plurality of electromagnetic coils or windings which may be actively controlled to rotatably drive the ring chuck (102) through corresponding permanent magnets provided on the rotor (103). Axial and radial bearing of the ring chuck (102) may be accomplished also by active control of the stator or by permanent magnets. Thus, the ring chuck (102) may be levitated and rotatably driven free from mechanical contact.

Alternatively the ring chuck may be held by a passive bearing where the magnets of the ring chuck are held by corresponding high-temperature-superconducting magnets (HTS-magnets) that are circumferentially arranged on an outer ring chuck outside the chamber. With this alternative embodiment each magnet of the ring chuck is pinned to its corresponding HTS-magnets of the outer rotor. Therefore the inner rotor makes the same movement as the outer rotor without being physically connected.

The inner cover plate (131) is perforated by a medium inlet (110). Similarly, the bottom plate (136) is perforated by a medium inlet (109). During processing of a wafer, processing fluids may be directed through medium inlet (109) and/or (110) to a rotating wafer in order to perform various processes, such as etching, cleaning, rinsing, and any other desired surface treatment of the wafer undergoing processing.

Within the lower chamber of the closed process chamber, one or more vertically movable splash guards (111, 115) are provided. In FIG. 1 two circular splash guards (111 and 115) are shown although it will be appreciated that any desired number of splash guards may be provided, or that the splash guards may be omitted altogether.

Drain (117) extends through the base plate (136) and opens to the inner fluid collector defined by splash guard (115), while drain (108) extends through the base plate (136) and opens to the outer fluid collector defined by splash guard (111). Preferably, base plate (136) is slanted relative to a horizontal plane toward each of the drains (108) and (117), such that fluid that is collected by the inner or outer fluid collector is caused to flow along the base plate (136) toward the drains (117) and (118).

An exhaust opening (106) leading to the closed process chamber also is provided to facilitate the flow of air and/or other gases and fumes.

Each splash guard is independently movable in the vertical direction. Accordingly, each splash guard can selectively be raised and/or lowered relative to the ring chuck (102), and relative to any other splash guard, such that excess process fluid emanating from the trailing edge of the ring chuck (122) is directed toward a selected fluid collector.

One or more actuators are provided outside of the closed process chamber in order to facilitate the selective and independent movement of each splash guard. For example, an actuator (113) is operatively associated with the outer splash guard (111) and another actuator (116) is operatively associated with the inner splash guard (115). Preferably three actuators are provided for each splash guard, although the number of actuators used will depend in part upon the geometric shape of the associated splash guard.

Actuators (113, 116) are provided with permanent magnets which correspond with permanent magnets carried by the splash guards (111, 115). Thus, selective vertical movement of each splash guard can be provided by the actuators through magnetic couples formed by the opposing sets of permanent magnets.

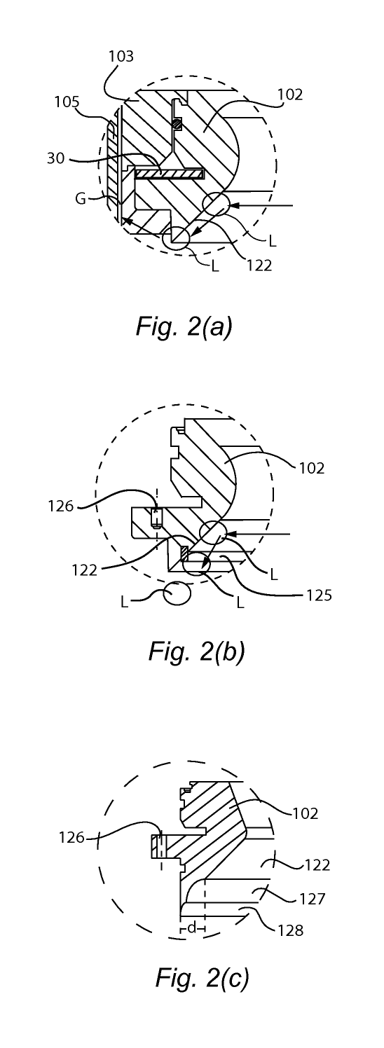

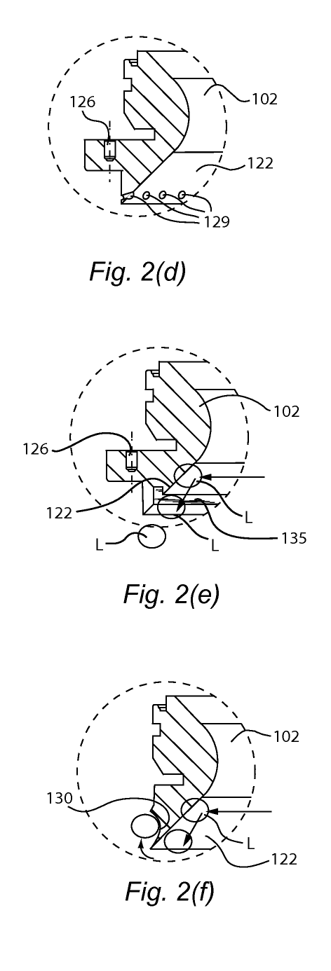

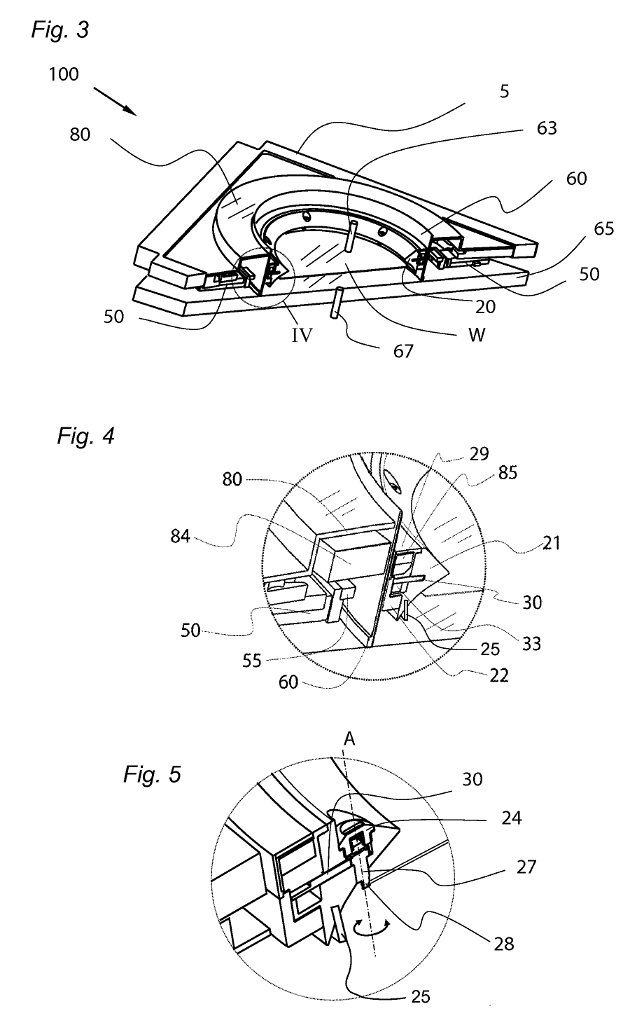

Referring now to FIG. 2(a), the ring chuck also includes a ring gear (30) seated within the ring chuck structure, as will be described in greater detail in connection with the embodiment of FIG. 3.

The ring chuck (102) further includes a trailing edge (122) which is oriented at a downward angle directed radially outward from the rotational axis of the ring chuck (102), as shown in FIG. 2(a). Thus, centrifugal action created by a spinning wafer causes excess process fluid, which has been dispensed through medium inlet (109) or (110), to be driven against an angled surface of the ring chuck (102) and directed in a downward and outward direction from the trailing edge (122).

However, the present inventors have discovered that a construction such as that depicted in FIG. 2(a) does not result in all of the process liquid being directed downwardly and outwardly of the ring chuck (102) after it has resided on a surface of wafer W. Instead, droplets or streams L of used process liquid also migrate upwardly and outwardly, where they enter the gap G between the rotor (103) and the cylindrical chamber wall (105).

Accumulation of the treatment liquid in the gap G between the rotating chuck (102) and the surrounding chamber wall (105) adversely influences the motor performance and can alter the on-wafer performance (process results) as well.

Thus, as illustrated in FIG. 2(b), the device according to an embodiment of the present invention includes a spoiler 125 in the form of a cylindrical baffle that depends downwardly from the trailing surface (122). Spoiler (125) in this case is oriented vertically, but it could also be oriented at an oblique angle. However, spoiler (125) should be oriented more vertically than trailing surface (122).

As shown in FIG. 2(b), spoiler (125) prevents the upward migration of liquid droplets L, directing them instead toward the collection chamber, or, in the case of a device with plural collection chambers, to the appropriate collection chamber.

Reference numeral (126) in FIG. 2(b) denotes a bore that receives a bolt for attachment of ring gear 30. A plurality of such bores (126) are formed on the ring chuck (102). Ring gear (30) comprises a corresponding series of slots through which these bolts will pass, with the slots permitting relative rotation between the ring gear (30) and the ring chuck (102) over a defined angular range at the time of opening or closing the gripping pins.

Referring now to FIG. 2(c), upward ingress of process liquid is prevented in this embodiment by a pair of concave surfaces formed in the lower and radially outermost region of trailing edge (122). In particular, concave surface (127) and concave surface (128) are formed adjacent to one another, and are separated by a discontinuity in trailing edge surface (122). Together these surfaces (127) and (128) occupy a radial distance “d” on the outer periphery of trailing edge (122). The ring chuck structure of FIG. 2(c) thus directs used process liquid more reliably along the intended path, in a manner similar to the embodiment of FIG. 2(b).

In the embodiment of FIG. 2(d), upward ingress of process liquid is prevented by forming a series of openings (129) in the lower and radially outermost region of trailing edge (122). Openings (129) pass through the lower portion of ring chuck (102), and thus direct used process liquid radially outwardly and away from the gap G between ring chuck (102) and chamber wall (105).

Openings (129), like the structures of the other disclosed embodiments of the present invention, serve also to disrupt the flow of used process liquid that is expelled radially outwardly off of the wafer surfaces, promoting the formation of droplets and disrupting any laminar flow. The disclosed embodiments thus not only deflect the used process liquids but also decrease their velocity and flow energy. The droplets of used process liquid formed by the present devices have a lower tendency to travel around the outermost chuck edge and can be more readily spun off.

Referring now to FIG. 2(e), the device according to a further embodiment of the present invention includes an annular slit (135) formed in the trailing surface (122). Slit (135) in this case extends continuously along the entire circumference of surface (122); however, slit (135) could instead be formed as a series of discontinuous arcuate slits. The width of slit (135) as it opens on the face of trailing surface (122), as well as its depth, are selected to disrupt the flow of liquid radially outwardly along trailing surface (122).

As shown in FIG. 2(e), slit (135) prevents the upward migration of liquid droplets L, directing them instead toward the collection chamber, or, in the case of a device with plural collection chambers, to the appropriate collection chamber.

Referring now to FIG. 2(f), upward ingress of process liquid is prevented in this embodiment by a concave trap (130) formed in a radially outwardly facing surface of the ring chuck that is positioned radially outwardly of and axially above the trailing edge surface (122). Concave trap (130) is preferably annular, extending across the entire circumference of ring chuck (102).

Those skilled in the art will recognize that the structures disclosed in connection with FIGS. 2(b)-2(f) are not necessarily alternative to one another, but may also be used together in any appropriate combination.

FIG. 3 depicts an alternative embodiment of a ring chuck to which the present invention may be applied. The chuck (100) of FIG. 3 comprises a chamber, an annular chuck (20) for gripping and rotating a wafer-shaped article W, and a stator (80). The chamber comprises a cylindrical wall (60), a bottom plate (65) and a top plate (not shown). An upper dispensing tube (63) is led through the top plate and a lower dispensing tube (67) through the bottom plate (65).

Stator (80) is mounted to a stator base plate (5) and is concentric with the cylindrical wall (60). The stator base plate (5) can be moved axially along the axis of the cylindrical wall (60), e.g. with pneumatic lifting devices. The stator base plate (5) and the stator (80) mounted thereto have central openings, whose diameter is greater than the outer diameter of the cylindrical wall (60). The top plate (25) can also be moved axially to open the chamber. In its closed position the top plate is sealed against the cylindrical wall (60).

As shown in FIG. 4, the stator (80) comprises several coils (84) for axial and radial orientation and for driving the rotor (85), which is part of the annular chuck. The diameter of the annular chuck (20) is less than the inner diameter of the cylindrical wall so that it can freely levitate and rotate within the cylindrical wall (60). The annular chuck (20) comprises an inner chuck base body (21) with an annular groove circumferentially surrounding the outside of the inner chuck base body (21), with the annular groove receiving the gear ring (30). The gear ring (30) is preferably made of PEEK, aluminum, or stainless steel. Gear ring (30) comprises inwardly facing teeth that drive the teeth of a pin shaft (27) (see FIG. 5).

This embodiment has six downwardly oriented pin shafts (27), each of which has a small gear, which is driven by the gear ring (30). The pin shafts (27) are mounted so that they can turn about an axis A, which is parallel to the rotation axis of the annular chuck.

A pin (28) is mounted to or formed integrally with each pin shaft (27), at a position that is eccentric with respect to the axis of rotation A of the pin shaft (27).

Consequently, the pins (28) are displaced radially of the chuck when the pin shafts (27) are turned by the gear ring (30). As the pins and the gear ring (30) are both carried by the chuck base body (21), the pins shafts (27) are rotated by the gear ring (30) only when the gear ring (30) rotates relative to the chuck base body.

Pins (28) are positioned so as to contact a wafer W on its peripheral edge. As the pins (28) also support the weight of the wafer W, the pins (28) may either be cylindrical in shape or have recessed portions on their radially inwardly facing sides contacting the wafer edge, to prevent axial displacement of the wafer W relative to the pins (28) when the wafer is being gripped.

In order to mount the gear ring (30) into the annular groove of the chuck base body (21) the gear ring (30) consists of two separate segments, which are fixed together when inserted into the annular groove.

Two permanent magnets (33) (see FIG. 4) are mounted to the tooth gear ring (30). A plurality of at least twenty-four rotor magnets (85), which are permanent magnets, are evenly arranged around the chuck base body (21). These rotor magnets (85) are part of the drive and positioning unit, namely, part of the ring chuck (elements of the active bearing), which is mounted to the chuck base body (21).

The plurality of rotor magnets (85) and the gear ring (30) carrying the permanent magnets (33) are encapsulated in a hollow annular space provided by the chuck base body (21), outer lower chuck cover (22), and the rotor magnet cover (29). Such rotor magnet cover (29) can be a stainless steal jacket.

The covers (22) and (29) are annular and concentric with the chuck base body (21).

When assembling the chuck (20) the pin shafts (27) are inserted from above into their respective seats so that the pin shafts tightly seal against the chuck base body 21 as shown in FIG. 5. Each pin shaft (27) is fixed in position with a screw (24). Additionally, each pin shaft may be pressed into its seat by a helical spring between the pin shaft and the screw.

Attached to the stator base plate 5 is the stator and active positioning unit (80) which is concentrically arranged with respect to the cylindrical wall (60). The positioning unit (80) corresponds with the rotor magnets (85) therefore levitating, positioning and rotating the chuck (20).

Below the active positioning unit (80) there are two pneumatic cylinders (50) mounted to the stator base plate (5). On the distal ends of the rods of the pneumatic cylinders (50) locking magnets (55) (permanent magnets) are arranged. The locking magnets correspond to the permanent magnets (33) of the gear ring (30). The pneumatic cylinders (50) are arranged so that the locking magnets (55) can be radially moved with respect to the axis of the cylindrical wall (60).

When the pins are to be opened e.g. to release a wafer the following procedure is conducted: the stator base plate (5) is lifted and therewith the levitating chuck (20) so that the cylindrical wall (60) is no longer in the gap between the locking magnets (55) and the chuck (20) (see FIG. 5).

Thereafter the pneumatic cylinders (50) move the locking magnets (55) in close proximity to the chuck (20) and the chuck is turned so that the permanent magnets (33) and therewith the gear ring (30) is locked by the locking magnets. Now the chuck is turned while the gear ring stands still and thus the pins (28) open. Alternatively the chuck base body might stand still while the pneumatic cylinders are moved so that the locking magnets tangentially turn (along the circumference of the chuck), whereby the gear ring is turned.

As shown in FIGS. 4 and 5, the chuck base body (21) of this embodiment is provided with a spoiler (25) whose construction and function are as described above in connection with the spoiler (125) of the embodiment of FIG. 2(b).

Similarly, the chuck as described in connection with present FIGS. 3-5 may alternatively or in addition be equipped with any one or more of the constructions described above in connection with FIGS. 2(c), 2(d) and 2(e).

While the present invention has been described in connection with various illustrative embodiments thereof, it is to be understood that those embodiments should not be used as a pretext to limit the scope of protection conferred by the true scope and spirit of the appended claims.

What is claimed is:

1. Device for liquid treatment of a wafer-shaped articles, comprising a closed process chamber, a ring chuck located within said closed process chamber, said ring chuck being adapted to be driven without physical contact through a magnetic bearing, a magnetic stator surrounding said closed process chamber, said closed process chamber comprising a cylindrical wall positioned between the ring chuck and the magnetic stator during liquid treatment of a wafer-shaped article, and the ring chuck has a form for preventing upward ingress of processing liquid into a gap defined between said ring chuck and said cylindrical wall

2. The device according to claim 1, wherein the ring chuck comprises a downwardly-depending spoiler extending from a downwardly- and inwardly-facing surface of the ring chuck.

3. The device according to claim 2, wherein the spoiler extends from the ring chuck in a more vertical orientation than the downwardly-facing surface of the ring chuck from which it extends.

4. The device according to claim 1, wherein the ring chuck comprises a downwardly- and inwardly-facing fluid-directing surface that extends at an oblique angle to an axis of rotation of the ring chuck, and wherein the ring chuck further comprises at least one downwardly-facing annular concave surface formed in a radially outer region of the downwardly- and inwardly-facing fluid-directing surface of the ring chuck.

5. The device according to claim 4, wherein the ring chuck comprises two downwardly-facing annular concave surfaces formed in a radially outer region of the downwardly- and inwardly-facing fluid-directing surface of the ring chuck, wherein the two downwardly-facing annular concave surfaces are adjacent to one another and separated from one another by a discontinuity in the downwardly- and inwardly-facing fluid-directing surface of the ring chuck.

6. The device according to claim 1, wherein the ring chuck comprises a downwardly- and inwardly-facing fluid-directing surface that extends at an oblique angle to an axis of rotation of the ring chuck, and wherein the ring chuck further comprises an annular slit formed in said downwardly- and inwardly-facing fluid-directing surface of the ring chuck, said slit being dimensioned so as to disrupt a liquid flow across the downwardly- and inwardly-facing fluid-directing surface of the ring chuck.

7. The device according to claim 1, wherein the ring chuck comprises a downwardly-facing fluid-directing surface that extends at an oblique angle to an axis of rotation of the ring chuck, and wherein the ring chuck further comprises a series of openings formed in a radially outer region of the downwardly-facing fluid-directing surface of the ring chuck.

8. The device according to claim 1, wherein the ring chuck comprises a downwardly-facing fluid-directing surface that extends at an oblique angle to an axis of rotation of the ring chuck, and wherein the ring chuck further comprises an annular concave fluid trap formed in a radially outwardly facing surface of the ring chuck that is positioned radially outwardly of and axially above the downwardly-facing fluid-directing surface of the ring chuck.

9. The device according to claim 1, wherein said device is a spin chuck in a process module for single wafer wet processing.

10. The device according to claim 1, wherein the ring chuck comprises a series of contact elements projecting downwardly from the ring chuck and adapted to hold a wafer-shaped article suspended from an underside of the ring chuck.

11. The device according to claim 10, wherein the contact elements are a series of pins that are conjointly movable between a radially inner position in which they contact a wafer-shaped article to a radially outer position in which they release the wafer-shaped article.

12. The device according to claim 11, wherein the pins are arranged in a circular series, and each pin projects from a respective pivotal base along an axis parallel to and offset from a pivot axis of said pivotal base.

13. The device according to claim 11, further comprising a vertical movement actuator operatively associated with said stator.

14. The device according to claim 13, wherein said vertical movement actuator is operatively associated with said stator through a magnetic couple.

15. The device according to claim 1, wherein the magnetic bearing is an active magnetic bearing.
